(19) United States
(12) Patent Application Publication
(10) Pub. No.: US 2007/0098455 A1
(43) Pub. Date: May 3, 2007

(54) APPARATUS FOR IMAGE FORMING AND IMAGE DEVELOPING WITH AN IMPROVEMENT OF TONER CONTAINER HOLDING

(76) Inventors: Kazuosa Kuma, Yokohama-shi (JP); Yuusuke Noguchi, Yokosuka-shi (JP); Hiroshi Ishii, Yokohama-shi (JP); Makoto Kikura, Yokohama-shi (JP); Yutaka Fukuchi, Yokohama-shi (JP); Kazuki Suzuki, Kawaguchi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/612,967

(22) Filed: Dec. 19, 2006

Related U.S. Application Data
(63) Continuation of application No. 11/066,270, filed on Feb. 28, 2005, now Pat. No. 7,174,121.

(30) Foreign Application Priority Data
Feb. 27, 2004 (JP) 2004-054810

(51) Int. Cl. G03G 15/08

(52) U.S. Cl. 399/258

(57) ABSTRACT

An image forming apparatus includes a toner container, an image development mechanism, and a toner container holder. The toner container has a longitudinal length with first and second longitudinal ends, is driven for rotation to move the toner. The image development mechanism develops an electrostatic latent image into a toner image. The toner container holder includes a base plate onto which the toner container is inserted in a direction perpendicular to the longitudinal direction of the toner container. The toner container holder further includes first and second supporters. The first and second supporters are mounted in traversal edge sides of the base plate and support the first and second longitudinal ends of the toner container, respectively.

### BACKGROUND OF THE INVENTION

1. Field of the Invention

The present invention relates to an apparatus for image forming and image developing, and more particularly to an apparatus for image forming and image developing which have an improvement of a toner container holding mechanism.

2. Discussion of the Background

Generally, an electrophotographic image forming apparatus such as a copying machine, a facsimile machine, a printer, a printing machine, and so on forms an image in a specific procedure of an electrophotographic method. That is, an electrostatic latent image is formed on an image carrying member such as a photosensitive drum and is subsequently developed with toner into a visual toner image. After that, the toner image is transferred and fixed onto a recording sheet. Thereby, an image is produced.

To develop an image, a development agent including the toner is used. There are two types of development agent: a one-component development agent having a main component of toner particles and a two-component development agent having two main components of toner particles and carrier particles. For both of the development agents, toner particles are contained in a toner container and are supplied in response to an amount of toner particles consumed in image forming.

FIG. 1 illustrates an exemplary toner container 10 which is configured to contain toner particles. The toner container 10 is formed in a cylindrical shape and includes an opening 10a and a spiral groove lob. The opening 10a is formed at an outer end of a thin neck projected from the toner container 10, from which the toner particles are discharged. The spiral groove lob is formed inner and outer circumferential surfaces of the toner container across one end to the other end of the toner container.

FIG. 2 illustrates an exemplary supporting mechanism 20 which includes a drive motor unit 21, a base plate 22, and a cap member 23. The drive motor unit 21 supports one end of the toner container 10 and drives it to rotate. When the toner container 10 is rotated, the toner particles container inside the toner container 10 are moved along the spiral groove in a rotational axis of the toner container 10. The base plate 22 and the cap member 23 are integrated in a single component. The base plate 22 includes a pair of rollers 22a for rotatably supporting the toner container 10 from below. The cap member 23 includes a closure 23a and a lock lever 23b. The closure 23a closes the opening 10a when the toner container 10 is set to a position in the supporting mechanism 20 such that one end of the toner container 10, having the opening 10a, is securely inserted to the cap member 23 after being placed on the base plate 22 and pushed towards the cap member 23. After that, the drive motor unit 21 is turned to a predetermined position to hold the other end of the toner container 10. After the toner container 10 is set to such a position, the lock lever 23b is turned to a lock position so that the toner container 10 is securely held by the supporting mechanism 20.

The cap member 23 includes a connecting member (not sown) which connects, through the closure 23a, the inside of the toner container 10 and a development mechanism of an image forming apparatus and transfers the toner particles in the toner container 10 to the development mechanism.

In the above-described mechanism, it is often not easy to cause the opening 10a to precisely meet its counter part of the closure 23a by pushing the toner container 10 from the other end thereof. In addition, it is also often caused that a vibration is generated at the end of the toner container 10 having the opening 10a due to a rotational torque given to the other end by the drive motor unit 21. Such a vibration may cause a problem in which the toner container 10 comes off from the closure 23a.

### SUMMARY OF THE INVENTION

This patent specification describes a novel image forming apparatus which improves a mechanism for supporting a toner container. In one example, a novel image forming apparatus includes a toner container, an image development mechanism, and a toner container holder. The toner container has a longitudinal length with first and second longitudinal ends. The toner container is configured to contain toner, to be driven for rotation by a portion close to the second longitudinal end, and to move the toner in a longitudinal direction of the toner container while the toner container is driven for rotation. The image development mechanism is configured to develop an electrostatic latent image into a toner image with the toner contained in the toner container. The toner container holder is configured to hold the toner container. The toner container holder includes a base plate which is configured to form an upper-open space in which the toner container is inserted in a direction perpendicular to the longitudinal direction of the toner container. The toner container holder further includes first and second supporters. The first supporter includes a base pillar having a top portion and a bottom portion, is mounted by the bottom portion of the base pillar in a traversal edge side of the base plate, and is configured to support the first longitudinal end of the toner container. The second supporter is mounted in an opposite traversal edge side of the base plate and is configured to support the second longitudinal end of the toner container.

The first supporter may further include an arm-like extension member configured to have a free end extended to a place interfering an insertion of the toner container, to be pushed by an insertion of the toner container, and to support the toner container by pushing back with a resilience force of the arm-like extension member.

This patent specification further describes a novel image developing apparatus which improves a mechanism for supporting a toner container. In one example, a novel image developing apparatus includes an image development mechanism, a toner container driving mechanism, and a toner container holder. The image development mechanism is configured to develop an electrostatic latent image into a toner image with toner contained in a toner container. The toner container driving mechanism is configured to drive the toner container for rotation. The toner container holder is configured to hold the toner container and includes a based plate. The base plate is configured to form an upper-open space in which the toner container is inserted in a direction perpendicular to a longitudinal direction of the toner container. The toner container holder further includes first and second supporters. The first supporter includes a base pillar having a top portion and a bottom portion, is mounted by the bottom portion of the base pillar in a traversal edge side of the base plate, and is configured to support a first longitudinal end of the toner container. The second supporter is mounted in an opposite traversal edge side of the base plate and configured to support a second longitudinal end of the toner container.

This patent specification further describes a novel powder container holding apparatus which improves a mechanism for supporting a toner container. In one example, a novel powder container holding apparatus includes a base plate configured to form an upper-open space in which a powder container is inserted in a direction perpendicular to a longitudinal direction of the powder container. The powder container is configured to be rotated to move powder contained therein along the longitudinal direction of the powder container. The novel powder container further includes first and second supporters. The first supporter includes a top portion and a bottom portion, is mounted by the bottom portion in a traversal edge side of the base plate, and is configured to support a first longitudinal end of the powder container. The second supporter is mounted in an opposite traversal edge side of the base plate and is configured to support a second longitudinal end of the powder container.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic illustration showing a background mechanism for holding a toner container;

FIG. 2 is a schematic illustration showing a supporting member for supporting the toner container included in the background mechanism;

FIG. 3 is a schematic illustration of an image forming apparatus according to an exemplary embodiment of the present invention;

FIG. 4 is a schematic illustration of a toner container supporter included in the image forming apparatus of FIG. 3 in which a toner container for black, for example, is placed;

FIG. 5 is a schematic illustration of an exemplary structure for supporting the toner container;

FIGS. 6A and 6B are schematic illustrations of a stopper for stopping the toner container;

FIG. 7 is a schematic illustration of another stopper;

FIG. 8 is a schematic illustration of a modified toner container held by the stopper of FIG. 7;

FIGS. 9 and 10 are schematic illustrations of other stoppers having different shapes;

FIGS. 11A and 11B are schematic illustrations of an exemplary under-support of the toner container;

FIGS. 12A and 12B are schematic illustrations of another exemplary under-support of the toner container;

FIGS. 13A and 13B are schematic illustrations of another exemplary under-support of the toner container;

FIG. 14 is an schematic illustration of an exemplary support of the toner container using the stopper of FIG. 6A and the under-support of FIG. 13A;

FIGS. 15A and 15B are schematic illustrations of an exemplary mechanism for fitting a toner container stopper to a side plate of the base plate;

FIGS. 16A and 16B are schematic illustrations of another exemplary mechanism for fitting a toner container stopper to a side plate of the base plate;

FIG. 17 is a schematic illustration illustrating a relationship between a driven gear mounted to the toner container and an idle gear transmitting a driving force to the driven gear;

FIGS. 18A and 18B are schematic illustrations of another exemplary support of the toner container using another toner container stopper;

FIG. 19 is a schematic illustration of an exemplary mechanism for protecting a bottom of the toner container using a cap member;

FIG. 20 is a schematic illustration of another exemplary mechanism for protecting the bottom of the toner container; and

FIG. 21 is a schematic illustration of an exemplary mechanism for securely holding the toner containers and easily identifying colors of the toner containers.

### DETAILED DESCRIPTION OF PREFERRED EMBODIMENTS

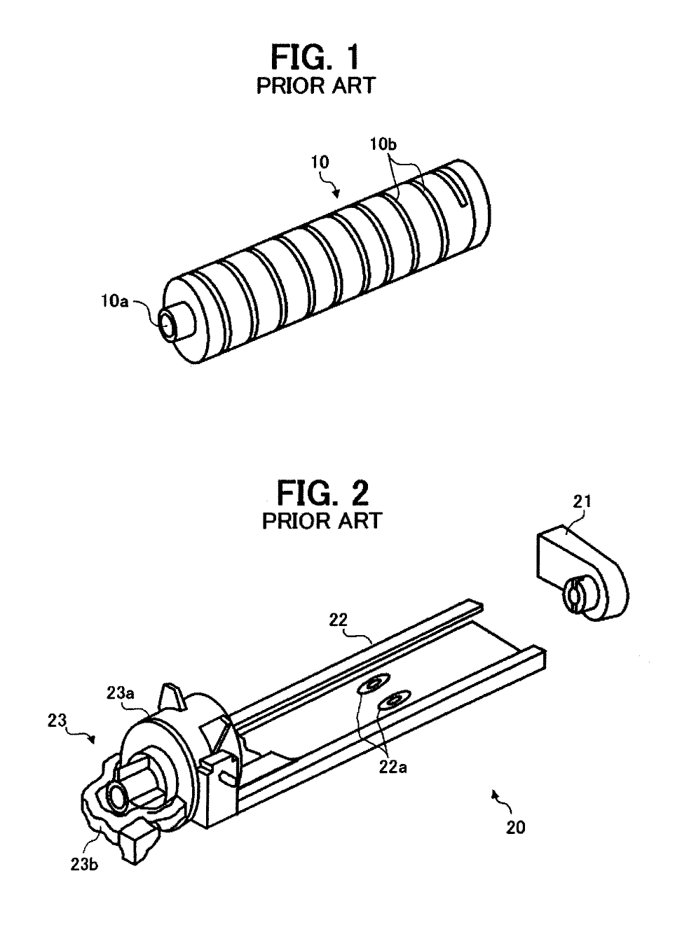

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, an electrophotographic image forming apparatus 1 according to an exemplary embodiment of the present invention is explained. The image forming apparatus 1 of FIG. 1 may be a color printer using a tandem-type image forming mechanism capable of producing a full-color image, a copying machine, a facsimile machine, a printing machine, or the like.

As illustrated in FIG. 1, the image forming apparatus 1 includes an optical unit 20, image forming units 21y, 21c, 21m, and 21k, a transfer unit 22, a manual sheet inserter 23, a sheet supply unit 24, a fixing unit 29, toner containers 31y, 31c, 31m, and 31k, an ejection tray portion 32, and a feed roller 33, a pair of registration rollers 34, a forward path 35, a path switch pawl 36, and a reverse path 37.

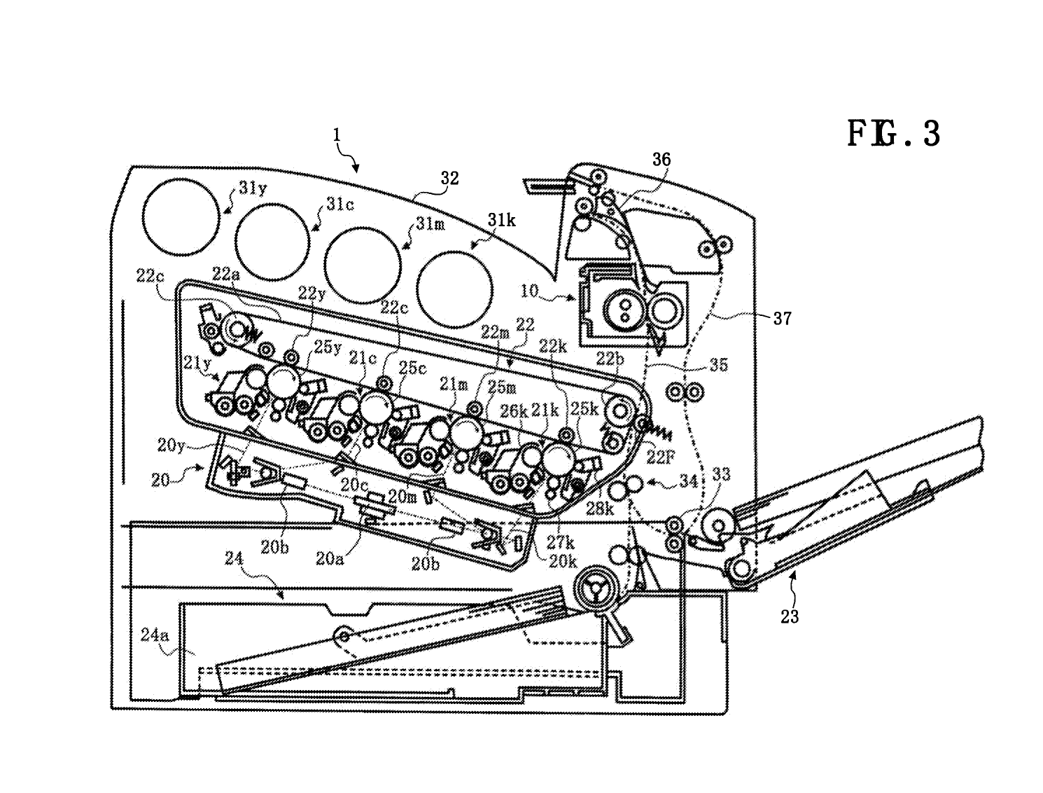

The optical unit 20 includes a multi-beam generating system which includes a polygon mirror 20a and a plurality of f-theta lenses 20b, and is configured to generate recording laser light beams 20y, 20c, 20m, and 20k. The image forming units 21y, 21c, 21m, and 21k are arranged in line and in parallel, as illustrated in FIG. 3, and are configured to form and develop images of yellow, cyan, magenta, and black color toners, respectively, in accordance with colors of an original image. The transfer unit 22 is arranged at a position in contact, from the above, with the image forming units 21y, 21c, 21m, and 21k. The manual sheet inserter 23 and the sheet supply unit 24 are selectively used, and each of them is configured to input a recording sheet into the image forming apparatus 1 toward the pair of registration rollers 34. The sheet supply unit 24 includes a sheet cassette 24a capable of containing a plurality of recording sheets. The pair of registration rollers 34 are configured to stop a recording sheet transported either from the manual sheet inserter 23 or the sheet supply unit 24 and to restart forwarding the recording sheet toward along the forward path 35 in synchronism with an image forming process performed by the image forming units 21y, 21c, 21m, and 21k and the transfer unit 22. The fixing unit 30 is configured to receive the recording sheet carrying an image of black or color toners thereon and to fix the image onto the recording sheet through a heat roller fixing operation. In general, this heat roller fixing operation conducts continuous processes of melting, softening, and osmosis by using a heat roller and a pressure roller arranged to contact each other, thereby fixing the image onto the recording sheet.

The image forming units 21y, 21, 21m, and 21k include photosensitive drums 25y, 25c, 25m, and 25k, respectively, and various other components. To avoid complexity in FIG. 3, components of the image forming unit 21k are representatively provided with requisite reference numerals, that is, the image forming unit 21k includes a development unit 26k, a charging unit 27k, and a cleaning unit 28k.

The transfer unit 22 includes a transfer belt 22a, a drive roller 22b, a driven roller 22c, primary transfer bias rollers 22y, 22c, 22m, and 22k, and a secondary transfer bias roller 22f. The transfer belt 22a is a looped belt extended among a plurality of rollers including the drive roller 22b, the driven roller 22c, and the primary transfer bias rollers 22y, 22c, 22m, and 22k. These primary transfer bias rollers 22y, 22c, 22m, and 22k are configured to apply a primary transfer bias having a polarity opposite to that of toner. They are arranged at positions opposite to corresponding photosensitive drums relative to the transfer belt 22a; for example, the primary transfer bias roller 22k faces the photosensitive drum 25k via the transfer belt 22a. With such a structure, the transfer unit 22 applies, in a case of forming a full-color image, the primary transfer bias having the opposite polarity relative to the toner's polarity through the primary transfer bias rollers 22y, 22c, 22m, and 22k to the transfer belt 22a. As a consequence, the toner images sequentially formed by the respective image forming units 21y, 21c, 21m, and 21k are sequentially transferred to the same position on the transfer belt 22a, thereby forming a single full-color image on the transfer belt 22a. The secondary transfer bias roller 22f is arranged at a position facing the drive roller 22b and is configured to transfer the single full-color image at a time from the transfer belt 22a to the recording sheet conveyed along the sheet path 35.

The above-described image forming apparatus 1 is capable of using a wide range of recording sheets including an ordinary copier paper, a relatively thick sheet such as a sheet for an overhead projector, a card, and a special sheet such as an envelope having a relatively greater thermal capacity.

The image forming units 21y, 21c, 21m, and 21k, which form and develop images of yellow, cyan, magenta, and black color toners, respectively, have structures similar to each other and operate in similar manners. Therefore, in the following description, the image forming unit 21k is explained as a representative for the other image forming units 21y, 21c, and 21m.

In the image forming unit 21k of FIG. 3, the charging unit 27, the development unit 26k, the cleaning unit 28k are arranged in this order along the rotational direction of the photosensitive drum 25k. The photosensitive drum 25k serves as an image carrying member for carrying an electrostatic latent image. The recording laser light beam 20k generated by the optical unit 20 passes through a space between the charging unit 27k and the development unit 26k and impinges on the photosensitive drum 25k.

Generally, the image carrying member is not limited to the photosensitive drum such as the photosensitive drums 25y, 25c, 25m, and 25k and can be formed in a belt-like shape.

For each color, most of the image forming related components surrounding the corresponding photosensitive drum are structured in a single unit called a process cartridge (not shown).

In the image forming apparatus 1 of FIG. 3, the transfer unit 22 is arranged in a slightly slant orientation and therefore has a reduced footprint.

An exemplary image forming operation using the image forming unit 21k with the black toner is explained. Other image forming units 21y, 21c, and 21m perform image forming operations in a manner similar to the operation of the image forming unit 21k.

The image forming operation first perform a charging process in which the photosensitive drum 25k is driven by a main motor (not shown) and is discharged by the charging unit 27k with an AC (alternating current) bias which includes no DC (direct current) element so that its surface is set to a reference voltage of about −50 volts.

Then, the photosensitive drum 25k is applied a DC bias superimposed by an AC bias, and the surface is evenly charged to a voltage substantially equal to the DC bias; at this time, the surface voltage is in a range of from approximately −500 volts to approximately −700 volts. A target charge potential charged at the surface is determined by each process controller for controlling the corresponding image forming operation.

After the charging process, the charged surface of the photosensitive drum 25k is subjected to a recording process. That is, the optical unit 20 causes a laser light source (not shown) included therein to emit the recording laser light beam 20k in accordance with a signal representing binary color data (i.e., black data) made based on digital image information. The recording laser light beam 20k emitted from the laser light source is controlled by a corresponding set of various optical elements, including cylindrical lens (not shown), the polygon mirror 20a, and the plurality of f-theta lenses 20b, and is finally caused to impinge on the evenly charged surface of the photosensitive drum 25k. When a place of the charged surface of the photosensitive drum 25k is exposed to the recording laser light beam 20k, the surface potential of the place becomes approximately −50 volts, thereby forming an electrostatic latent image in accordance with the digital image information on the surface of the photosensitive drum 25k.

The electrostatic latent image thus formed on the photosensitive drum 25k is then developed with the black toner by the development unit 26k, since in this case the color of the digital image information is black. For other colors, one of the yellow, cyan, and magenta color toners is used based on a complementary color relationship with the color of the digital color information whose color is one of the colors separated from the original image through color separation. The development unit 26k includes a development sleeve (not shown) for conveying toner to the surface of the photosensitive drum 25k. More specifically, the development sleeve is applied with a DC voltage in a range of from approximately −300 volts to approximately −500 volts to which an AC bias voltage is overlaid so as to develop a surface area of the photosensitive drum 25k where the potential is reduced by the exposure to the recording laser light beam 20k with the toner (i.e., the black toner) having a specific charge in a range of from approximately −20 μC/g to approximately −30 μC/g. Thereby, the electrostatic latent image is developed into a black toner image. Similar operations are sequentially performed for other colors, and yellow, cyan, and magenta color toner images are formed accordingly.

Then, the primary transfer bias rollers 22y, 22c, 22m, and 22k, facing the photosensitive drums 25y, 25c, 25m, and 25k, respectively, relative to the transfer belt 22a, are applied with a bias voltage having the reverse polarity to that of the toners so that the toner images developed are electrostatically transferred onto the transfer belt 22a at the same position, thereby forming a full-colored toner image made of overlaid toner images. The secondary transfer bias roller 22f transfers the full-colored toner image carried on the transfer belt 22a to the recording sheet which is conveyed through the forward path 35 by the pair of registration rollers 34 in synchronism with the advance of the full-colored toner image carried by the transfer belt 22a.

After receiving the full-colored toner image from the transfer belt 22a, the recording sheet is separated from the transfer belt 22a by the action of curvature separation and is further conveyed to the fixing unit 30 conducting the fixing process. When the recording sheet reaches the fixing unit 30, the recording sheet passes through the fixing nip formed between the heat roller and the pressure roller so that the full-colored toner image is fixed onto the recording sheet. Then, the recording sheet is guided to the ejection tray portion 32 which is part of a housing of the image forming apparatus 1.

The image forming apparatus 1 of FIG. 3 is capable of performing not only a simplex image forming for forming an image on one side of recording sheet but also a duplex image forming for forming images on both sides of recording sheet. In the duplex image forming mode, the path switch pawl 36 is moved to a position so that the recording sheet after the fixing process on one side of the recording sheet is conveyed to a standby area and is subsequently reversed along the reverse path 37 towards the feed roller 33. Then, the recording sheet is again fed to the pair of registration rollers 34 via the feed roller 33 to face the transfer belt 22a with the other side of the recording sheet. Thereby, the next toner image formed on the transfer belt 22a is transferred onto the other side of the recording sheet by the secondary transfer bias roller 22f. As illustrated in FIG. 3, the path switch pawl 36 is arranged at a rear side of the fixing unit 30 and the feed roller 33 combines the functions for feeding such reversed recording sheet and those inserted from the manual sheet inserter 23.

The toner containers 31y, 31c, 31m, and 31k are connected to the development units 21y, 21c, 21m, and 21b, respectively, with respective toner supply pipes (not shown) so as to supply the respective color toners to the respective development units 21y, 21c, 21m, and 21b.

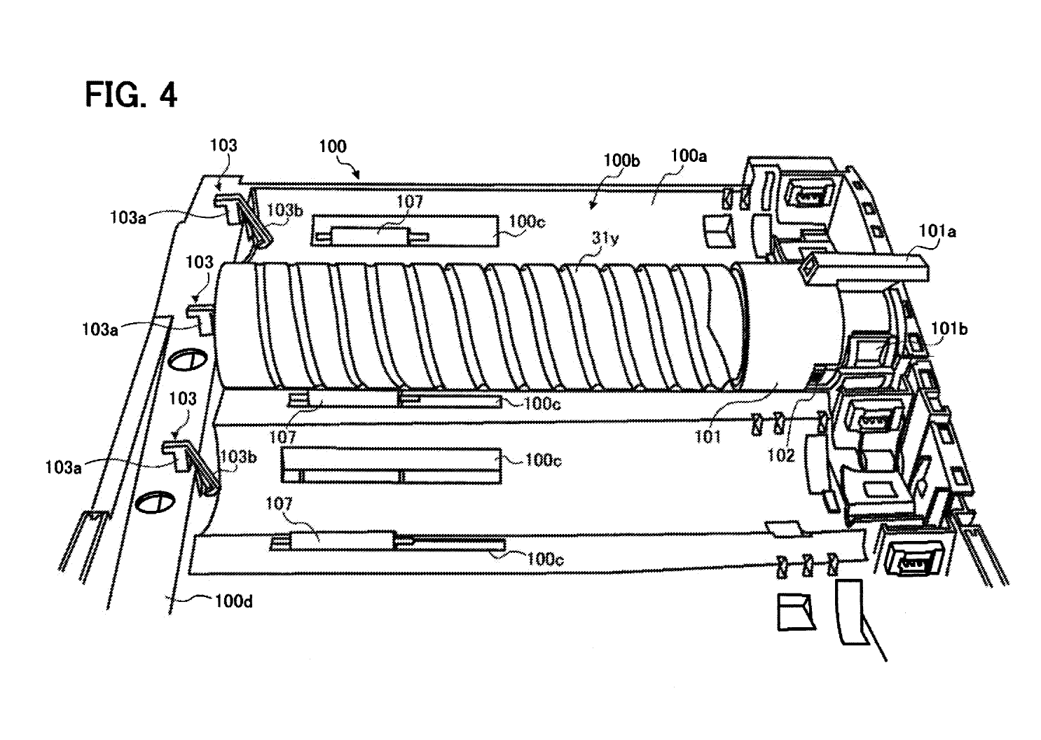

Referring to FIG. 4, an exemplary toner container supporter 100 included in the image forming apparatus 1 is explained. FIG. 4 illustrates a part of the toner container supporter 100 and the toner container 31y, as an example. The description for the toner container 31y can also be applied to other toner containers 31c, 31m, and 31b. The toner container supporter 100 includes a base plate 100a which forms a space 100b having an upward open shape, in which the toner container 31y is placed from above in a manner its longitudinal direction is made horizontal. The base plate 100a includes a plurality of openings 100c from which respective rollers 107 are exposed, which are explained in descriptions below. The toner container supporter 100 further includes a side plate 100d and stoppers 103. The stoppers 103 are made of a flexible material. Each stopper 103 includes a base pillar 103a and an extension portion 103b, and is fixed to the side plate 100d such that which the extension portion 103b holds with tension the toner container 31y at a first longitudinal end 104 thereof. The base pillar 103a and the extension portion 103b are formed in a single piece as the stopper 103.

As illustrated in FIG. 4, the toner container 31y includes a ring member 101 mounted to the outer surface of the toner container 31y at a second longitudinal end thereof which is opposite to the first longitudinal end 104 held by the stopper 103. The ring member 101 includes a grip portion 101 a which is formed in one piece with the ring member 101 for being held at an installation and a removal of the toner container 31y.

The toner container 31y also includes a driven gear 102 arranged inside the ring member 101 and formed in one piece with the toner container 31y.

The toner container 3ly has a spiral groove in an inside surface by which the toner contained inside is moved in a direction perpendicular to the rotation direction of the toner container 31y.

The ring member 101 of the toner container 31y includes a toner discharging opening 101b which is arranged at a position near the second longitudinal end and circumferentially away from the grip portion 101 a by 90 degrees so that when the grip portion 101a is turned by 90 degrees the toner discharging opening 101b is also turned by 90 degrees to face down a toner receiving opening (not shown) provided to the toner container supporter 100. Thus, by the grip portion 101a is turned by 90 degrees, the toner discharging opening 101b is connected to the toner receiving opening of the toner container supporter 100.

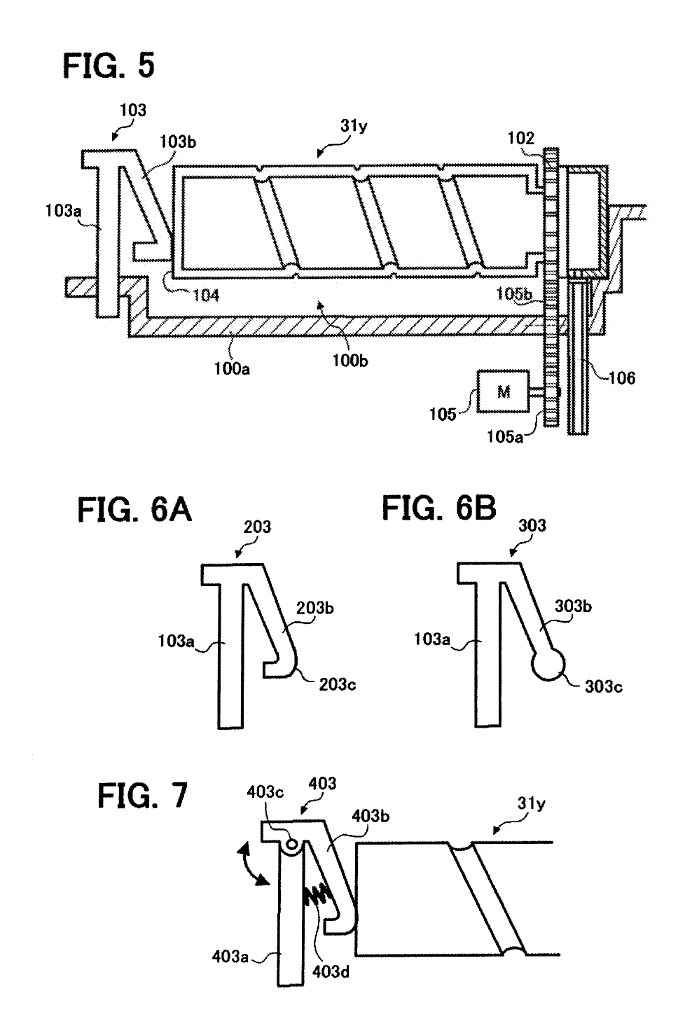

When the toner container 31y is placed in the space 100b, the toner container 31y needs to be settled firmly and stably at a predetermined position. This mechanism is explained with reference to FIG. 5, illustrating a state in which the toner container 31y is placed in the space 100b and is held by the extension portion 103b of the stopper 103. As illustrated in FIG. 5, the base pillar 103a has a T-like shape and is fixed to the base plate 100a.

The extension portion 103b is extended from a top of the stopper 103 with an angle towards an approximate center of the first longitudinal end 104 of the toner container 31y and has an end which engages with the first longitudinal end 104 of the toner container 31y with pressure.

The toner container 31y is driven for rotation by a motor 105 via a drive gear 105a and an idle gear 105b. As described above, the toner container 31y has the spiral groove in its inside surface and when the toner container 31y is rotated the toner contained inside is moved along the groove towards the toner discharging opening 101b near the second longitudinal end. Then, the toner is conveyed to the corresponding development unit through a toner transfer pipe 106.

At least one of the stopper 103 and the corresponding toner container includes a polyacetal resin which has a relatively low friction coefficient. Thus, it becomes possible to reduce a rubbing friction caused between the stopper and the toner container at an installation of the toner container.

To install the toner container 31y to the toner container supporter 100 having the above-described structure, the toner container 31y is placed down into the space 101b from above and, during the placement, an edge portion of the first longitudinal end 104 of the toner container 31y is guided along the extension portion 103b until it is settled.

On the other hand, the extension portion 103b extended to a position where it interferes the insertion of the toner container 31y is flexibly deformed to a position where it does not interfere but firmly holds the toner container 31y as the toner container 31y is downwardly and forcibly inserted to its operational position. When the toner container 31y is settled at a predetermined position, the extension portion 103b pushes with a resilient force thereof the first longitudinal end 104 of the toner container 31y in the longitudinal direction to hold it tightly and stably.

Thus, according to the present embodiment, the stopper 103 has the resilient force which is activated to continuously contact the first longitudinal end 104 of the toner container 31y as the toner container 31y is inserted to its operational position along the extension portion 103b. Thereby, it becomes possible that the toner container 31y is smoothly guided to and settled at its operational position.

FIGS. 6A and 6B illustrate other exemplary stoppers 203 and 303, respectively. The stopper 203 of FIG. 6A is similar to the stopper 103, except for an extension portion 203b which has a curved end 203c. With this configuration, the extension portion 203b contacts the first longitudinal end 104 of the toner container 31y with a minimal contact area so as to be able to minimize a rubbing friction caused between the stopper and the toner container at an installation of the toner container. It becomes also possible with this configuration to eliminate an accidental event which may be caused with the stopper 103 such that the first longitudinal end 104 of the toner container 31y is caught by the edge of the extension portion 103b. The stopper 303 of FIG. 6B is similar to the stopper 103, except for an extension portion 303b which has a round end 303c. With this configuration, the stopper 303 operates with the same effect as the stopper 203 does.

FIG. 7 illustrates further another exemplary stopper 403 which includes a straight pillar 403a, a leverage extension portion 403b, a pin 403c, and a coil spring 403d. The leverage extension portion 403b is movably mounted to the straight pillar 403a with the pin 403c, and the leverage extension portion 403 is pressed by the coil spring 403d towards the first longitudinal end 104 of the toner container 31y. With this structure, it becomes possible to adjust the spring force of the coil spring 403d to optimize a rubbing friction caused between the stopper and the toner container at an installation of the toner container. In addition, with this structure, the operator can easily feel a difference between resistances at a time of installing along the leverage extension portion 403c and at a time of settlement. That is, with such a tangible difference, the operator can easily realize a completion of installation.

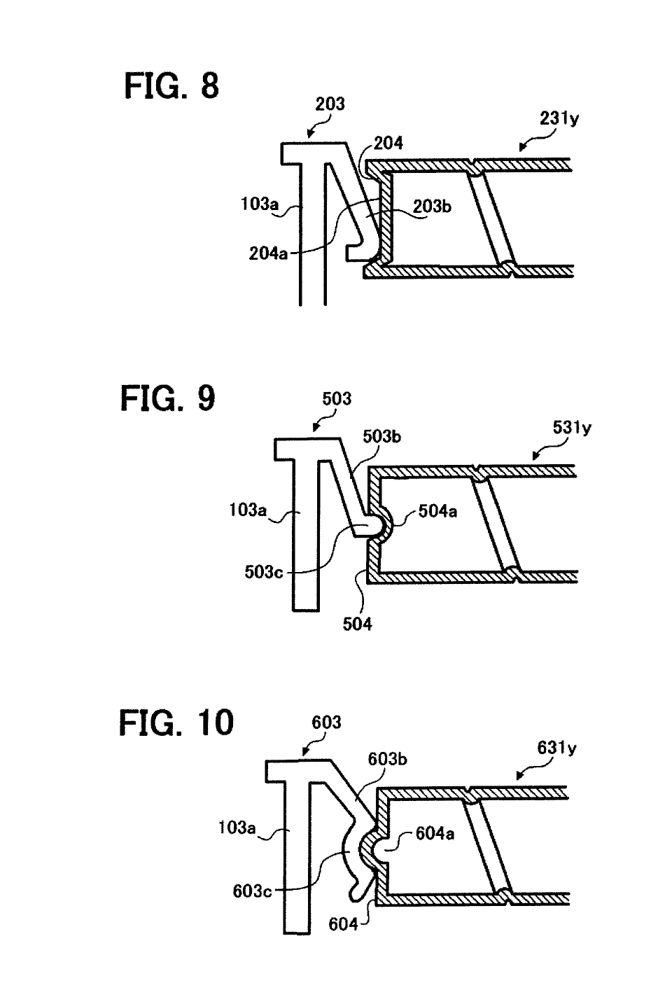

Referring to FIGS. 8-10, exemplary ways of engagement between the toner container and the stopper are explained. As illustrated in FIG. 8, a toner container 231y includes a first longitudinal end 204 which has a hollow 204a whose circumferential inner edge surface has a relatively small angle relative to a horizontal plane. The extension portion 203b of the stopper 203 has a flat surface following the curbed end 203c and is extended to the circumferential inner edge surface of the hollow 204a so that the flat surface of the extension portion 203b contacts the circumferential inner edge surface of the hollow 204a. This structure avoids an unexpected event in which the first longitudinal end 204 of the toner container 231y is disengaged from the extension portion 203b. Such an unexpected event may be caused by the action of rotational torque applied to the toner container 231y by the motor 105 through the drive gear 105a and the idle gear 105b. Such an unexpected event may also be caused by an erroneous operation by the operator to remove the toner container 231y.

FIG. 9 illustrates a toner container 531y and a stopper 503. The toner container 531y includes a first longitudinal end 504 having a semiround hollow 504a which is arranged at a rotational center of the toner container 531y. The stopper 503 includes an extension portion 503b having a semiround bent-end 503c. As illustrated in FIG. 9, when the toner container 531y is installed, the toner container 531y allows the stopper 503 to be engaged by its semiround bent-end 503c with the semiround hollow 504a of the toner container 531y so that the toner container 531y is rotatably supported.

FIG. 10 illustrates a toner container 631y and a stopper 603. The toner container 631y includes a first longitudinal end 604 having a semiround projection 604a which is arranged at a rotational center of the toner container 631y. The stopper 603 includes an extension portion 603b having a semiround end 603c. As illustrated in FIG. 10, when the toner container 631y is installed, the toner container 631y allows the stopper 603 to be engaged by its semiround end 603c with the semiround projection 604a of the toner container 631y so that the toner container 631y is rotatably supported.

These structures of FIGS. 9 and 10 avoid an unexpected event in which the first longitudinal end of the toner container is disengaged from the extension portion. Such an unexpected event may be caused by the action of rotational torque applied to the toner container by the motor through the drive gear and the idle gear. Such an unexpected event may also be caused by an erroneous operation by the operator to remove the toner container. In addition, since the extension portion of the stopper holds the toner container at the center of the toner container, the toner container can stably be rotated without developing an undesirable deflection.

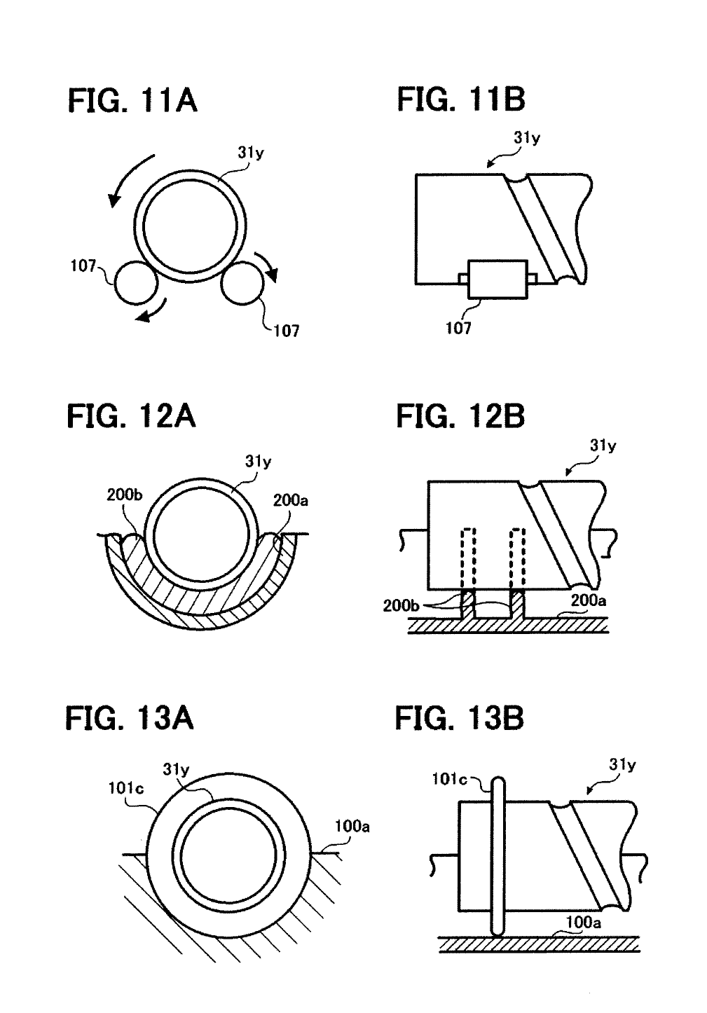

Referring to FIGS. 8A to 11, exemplary ways of stabling the toner container at rotation is explained. As illustrated in FIGS. 11A and 11B and also FIG. 4, the toner container 31y is supported by the rollers 107. The rollers 107 are projected from the openings 100c which are formed in the base plate 100a and near the first longitudinal end 104.

FIGS. 12A and 12B illustrate the toner container 31y supported by a base plate 200a with a pair of ring portions 200b. The pair of ring portions 200b of the base plate 200a are formed near the first longitudinal end 104 in a semiround shape to support the toner container 31y with minimal contacting areas.

FIGS. 13A and 13B illustrate the toner container 31y provided with a ring plate 101c which contacts the base plate 100a.

With these structures described above, the toner container can stably be rotated without developing an undesirable deflection.

The toner container supporter illustrated in FIGS. 11A and 11B, 12A and 12B, and 13A and 13B also includes one of the stoppers described above to hold the toner container.

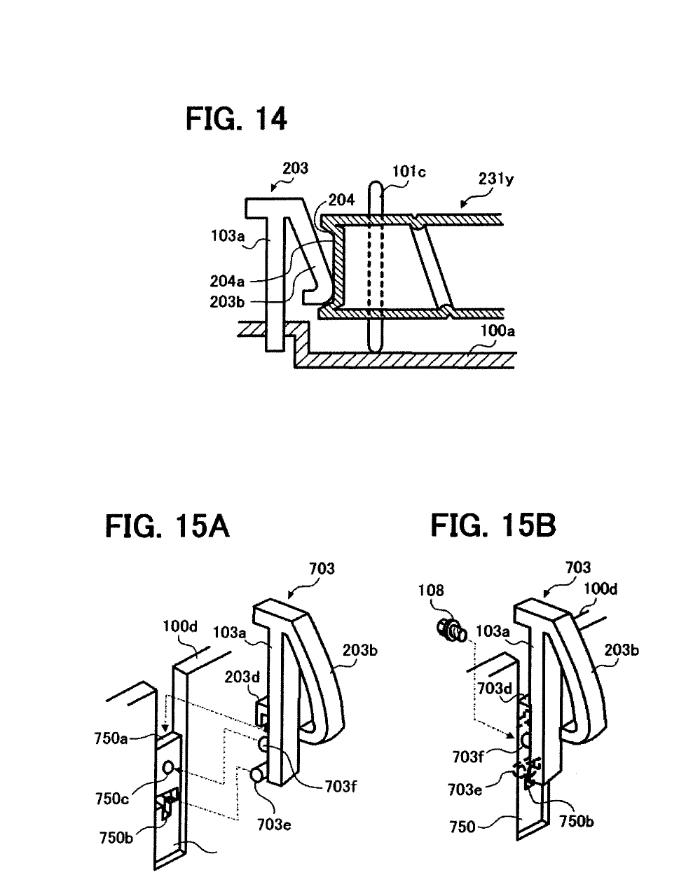

FIG. 14 illustrates a structure in which the toner container 31y having the ring plate 101c is held for rotation by the stopper 203 of FIG. 8. With this structure, it becomes possible to rotate the toner container in a stable manner without developing an undesirable deflection and to avoid an unexpected disengagement of the first longitudinal end of the toner container from the extension portion due to an erroneous operation to remove the toner container by the operator, for example.

Referring to FIGS. 15A and 15B, another exemplary mechanism for holding the toner container 31y is explained below. This mechanism uses a stopper 703. The stopper 703 of FIG. 15A is similar to the stopper 203 of FIG. 6A, except for first, second, and third fastening members 703d, 703e, and 703f which are mounted to a surface of the base pillar 103a, facing the side plate 100d. The first fastening member 703d has an L-like shape forming a downward-open space together with the surface of the base pillar 703a, and the second fastening member 703e has a T-like-pin shape having a leg portion (not shown) standing on the surface of the base pillar 103a. The third fastening member 703f has a pin shape standing between the first and second fastening members 703d and 703e on the base pillar 103a, as illustrated in FIG. 15A.

As also illustrated in FIG. 15A, the side plate 103d has a relatively thin thickness and includes a counter-fastening portion 750. This counter-fastening portion 750 includes top edge 750a, a T-like shaped hole 750b, and a vertically-oval-shaped hole 750c which are arranged at positions in a surface of the counter-fastening portion 750 to engage with the second and third fastening members 703e and 703f, respectively. More specifically, as illustrated in FIG. 15B, as a first step, the stopper 703 is attached to the counter-fastening portion 750 such that the first, second, and third fastening members 703d, 703e, and 703f contact the top edge 750a, the T-like shaped hole 750b, and the vertically-oval-shaped hole 750c, respectively. Then, the stopper 703 is pushed downward, so that the top edge 750a enters into the downward-open space of the first fastening member 703d, the leg portion of the second fastening member 703e slips into a leg portion of the T-like shaped hole 750b, and the third fastening member 703f slides down in and along the vertically-oval-shaped hole 750c. Thereby, the stopper 703 is firmly engaged with the counter-fastening portion 750, that is, with the side plate 100d. The stopper 703 is easily removed by following the above-described installation step in reverse.

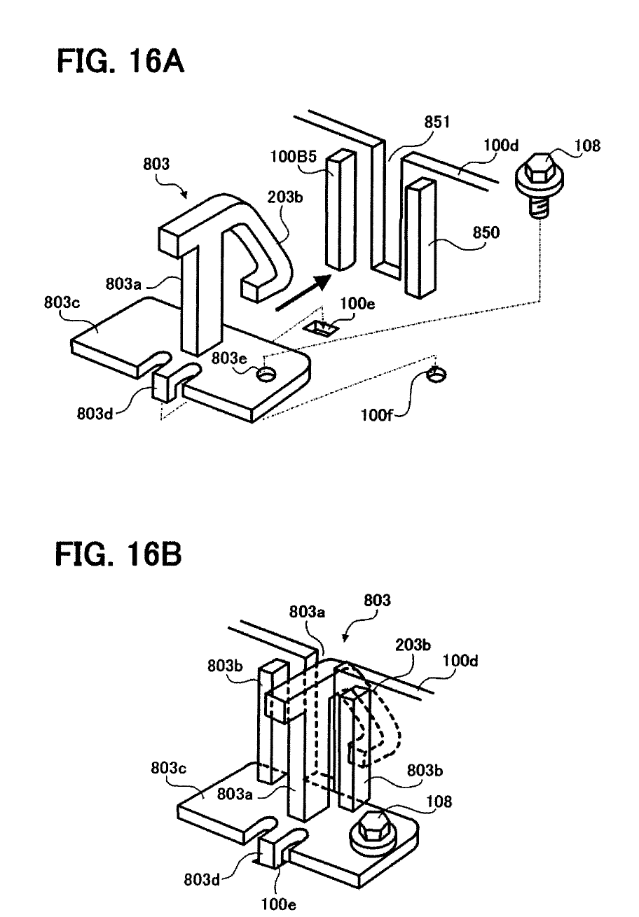

Referring to FIGS. 16A and 16B, another exemplary mechanism for holding the toner container 31y is explained below. This mechanism uses a stopper 803. The stopper 803 of FIG. 16A is similar to the stopper 203 of FIG. 6A, except for a base pillar 803a. The base pillar 803a includes a bottom plate 803c which has an upper surface on which the base pillar 803a stands, as illustrated in FIG. 16A, and the bottom plate 803c includes a hook 803d and a hole 803e.

As also illustrated in FIG. 16A, the side plate 100d of the toner container supporter 100 includes two rectangular bars 850 arranged at an outer surface of the side plate 100d, opposite to the toner container 31y, and a rectangular slit 851 which is arranged between the rectangular bars 850. To install this mechanism, the stepper 803 is placed at a position opposite to the toner container 31y relative to the side place 100d, as illustrated in FIG. 16A. Then, the stopper 803 is slid towards the side plate load so that the extension portion 203b of the stopper 803 is inserted into until the top leading edge of the bottom plate 803c contacts the surface of the side plate load under the rectangular bars 850. Consequently, the extension portion 203b of the stopper 803 is projected from the rectangular slit 851 of the side plate 100d and the hook 803d of the bottom plate 803c is inserted into a hole 100e of the base plate 100a. After that, the bottom plate 803c and the base plate 100a are fixed by a bolt 108 through the hole 803e and a hole 100f of the base plate 100a, as illustrated in FIG. 16B.

With this structure, the stopper 803 functions to stop and hold the toner container 31y in a manner similar to the stopper 203 of FIG. 6A. That is, the extension portion 203b of the stopper 803 is projected from the side plate load to the position where the extension portion 203b interferes the insertion of the toner container 31y and is flexibly deformed to a position where it does not interfere but firmly holds the toner container 31y as the toner container 31y is downwardly and forcibly inserted to its operational position.

Furthermore, with this structure, the rectangular bars 850 which hold the bottom plate 803c from above and therefore does not allow an upward movement of the stopper 803 which may mistakenly be caused by operators.

Thus, according to the present embodiment, the stopper 803 is detachably mounted to the toner container supporter 100 by the engagements between the hook 803d and the hole 100e and between the bottom plate 803c and the base plate 100a using the bolt 108 through the hole 803e and the hole 100f, by which the stopper 803 is accurately positioned relative to the toner container 31y without providing any extra positioning mechanism.

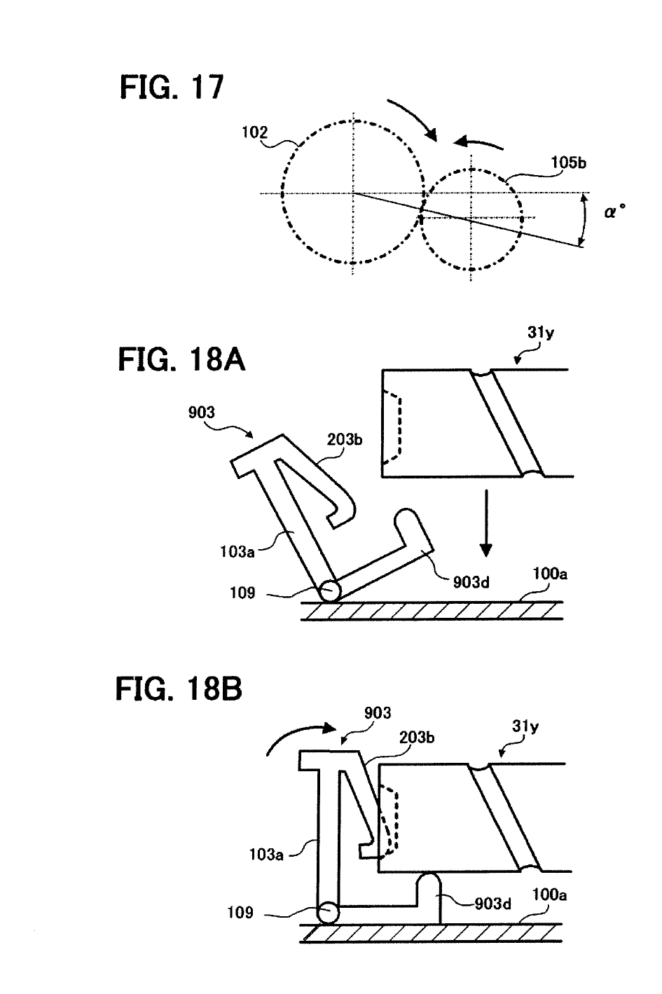

FIG. 17 illustrates a preferable relationship between the driven gear 102 and the idle gear 105b (also see FIG. 5). As illustrated in FIG. 17, the driven gear 102 and the idle gear 105b are configured to rotate in predetermined directions, as indicated with arrows in FIG. 17. As a result, the idle gear 105b gives a rotational torque to the driven gear 102 at a point contacting each other and consequently a downward force is generated downwardly at the axis of the driven gear 102. Such a downward force suppresses an undesirable upward movement of the toner container 31y. This downward force relates to the position of the axis of the idle gear 105b. In other words, the downward force becomes greater when the idle gear 105b is placed such that the axis thereof is below the axis of the driven gear 102 but smaller when the idle gear 105b is placed such that the axis thereof is above the axis of the driven gear 102. Therefore, it is preferable to place the idle gear 105b such that the axis of the idle gear 105b is below the axis of the driven gear 102.

As described above, according to the present embodiment, it becomes possible to secure that the toner container 31y is prevented from upward disengagement simply by regulating the rotational directions of the idle gear 105b and the driven gear 102.

Referring to FIGS. 18A and 18B, another exemplary mechanism for holding the toner container 31y is explained below. This mechanism uses a stopper 903. The stopper 903 of FIG. 18A is similar to the stopper 203 of FIG. 6A, except for a base pillar 903a. The base pillar 903a include a bottom leg 903d which has an L-like shape, as illustrated in FIG. 18A. The bottom leg 903d has one end at which the stopper 903 is rotatably fixed with a rotary pin 109 to the base plate 100a of the toner container supporter 100. The other end of the bottom leg 903d is angled and is configured to contact and support the circumferential surface of the toner container 31y from below when the toner container 31y is inserted and the stopper 903 is turned about the rotary pin 109, as illustrated in FIG. 18B.

This mechanism can achieve both reduction of frictional resistance from the extensional portion 203b when the toner container 31y is inserted to its operational position and securing the toner container 31y at its operational position after the toner container 31y is installed to the operational position.

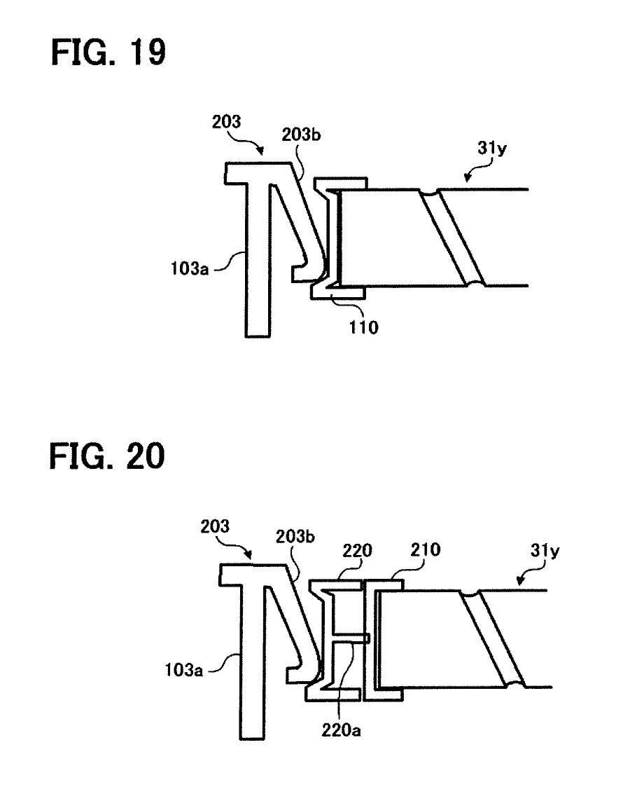

Referring to FIG. 19, an exemplary structure of increasing a durability of the first longitudinal end 104 of the toner container 31y, which is derived based on the structures illustrated in FIGS. 5 and 8. As illustrated in FIG. 19, the toner container 31y is provided with a cap member 110 to cover the first longitudinal end 104. The cap member 110 has an M-like shape tilted by 90 degrees and is installed to the first longitudinal end 104 of the toner container 31y such that the top hollow of the cap member 110 contacts the extensional portion 203b, as illustrated in FIG. 19. Therefore, the extensional portion 203b of the stopper 203 does not directly rub the first longitudinal end 104 of the toner container 31y during both the installation and the rotation of the toner container 31y, so that the durability of the toner container 31y will be increased. When the top hollow of the cap member 110 is worn by the friction with the stopper 203, this cap member 110 can be exchanged with a new cap member 110.

FIG. 20 illustrates another exemplary structure of increasing a durability of the first longitudinal end 104 of the toner container 31y. In this structure of FIG. 20, the toner container 31y is provided with a cap member 210 and a ring member 220. The cap member 210 has a U-like shape with a flat top and a dent in the outer surface of the flat top. The ring member 220 has a shape similar to the cap member 110 of FIG. 19, except for a center leg 220a which is provided at the center of the ring member 220. To install the ring member 220 to the cap member 210, the center leg 220a of the ring member 220 is inserted into the dent formed in the flat top of the cap member 210 so that the ring member 220 is rotatably held by the cap member 210, as illustrated in FIG. 20. Both cap member 210 and ring member 220 are exchangeable. For example, when they are worn out, they can be exchanged with a new one.

This structure achieves reduction of frictional resistance generated between the extensional portion 203b and the ring member 220 when the toner container 31y having the cap member 210 and the ring member 220 is inserted to its operational position and when the toner container 31y is rotated together with the cap member 210, and securing the toner container 31y its operational position after the toner container 31y is installed to the operational position.

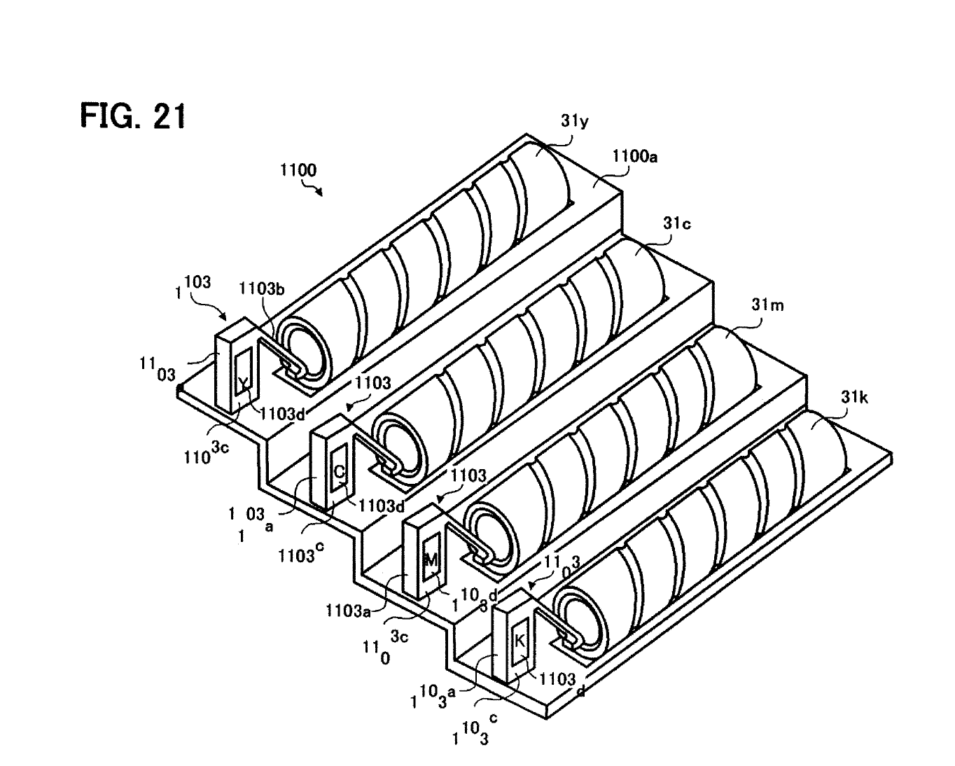

FIG. 21 illustrates an exemplary structure of a toner container supporter 1100 capable of securely holding the toner containers and easily identifying their colors. As illustrated in FIG. 21, the toner container supporter 1100 is similar to the toner container supporter 100 of FIG. 4, except for a base plate 100a and a stopper 1103. Although FIG. 21 does not show, the toner container supporter 1100 includes driving mechanisms similar to those illustrated in FIG. 4 for driving the toner containers 31y, 31c, 31m, and 31k.

As illustrated in FIG. 21, the base plate 1100a has four stages in a step-like shape at which the toner containers 31y, 31c, 31m, and 31k are placed. Each of the four stages of the base plate 100a is provided with the stopper 1103. The stopper 1103 is similar to the stopper 103 of FIG. 4, except for a base pillar 1103a which includes a plain surface 1103c greater than that of the stopper 103 of FIG. 4. Such a plain surface 1103c includes a color identification area 1103d which indicates a color of the corresponding toner container by a specific mark printed thereon such as, for example, a letter Y for the yellow toner container 31y or using the color itself.

This structure of FIG. 21, particularly, its step-like stages as well as the indication of the stoppers 1103, facilitates visual identification of the toner containers and prevents erroneous insertions of the toner containers to improper stages of the base plate 1100a.

The above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein.

This patent specification is based on Japanese patent application No. JPAP2004-054810 filed on Feb. 27, 2004 in the Japanese Patent Office, the entire contents of which are incorporated by reference herein.

What is claimed is:

1. An image forming apparatus, comprising:
a toner container configured to contain toner;
an image development mechanism configured to develop an electrostatic latent image with a developing unit into a toner image using the toner contained in said toner container; and
a toner container holder configured to hold said toner container, said toner container holder including a base plate configured to form an upper-open space into which said toner container is inserted from above in a substantially vertical direction.

2. The image forming apparatus according to claim 1, wherein said toner container holder is slantingly arranged.

3. The image forming apparatus according to claim 1, wherein said toner container holder is slantingly arranged such that an end side thereof close to a fixing unit is positioned lower than an opposite end side.

4. The image forming apparatus according to claim 1, wherein said toner container holder is slantingly arranged in a manner substantially parallel to an arrangement of a transfer belt upon which toner image is transferred.

5. The image forming apparatus according to claim 1, wherein said toner container holder is slantingly arranged in a manner substantially parallel to an arrangement of said image development mechanism.

6. The image forming apparatus according to claim 1, wherein said base plate of the toner container is covered by a cover, and wherein said cover includes an upper surface having an ejection tray portion configured to receive sheets ejected from said image forming apparatus.

7. The image forming apparatus according to claim 1, wherein said toner container holder further includes:
a first supporter supporting a first end of said toner container and including a base pillar having a top portion and a bottom portion, said bottom portion being mounted to said base plate; and
a second supporter supporting a second end of said toner container and mounted to said base plate,
wherein said first supporter further includes an arm-like extension member configured to have a free end extended to a place interfering with an insertion of said toner container, to be pushed by the insertion of said toner container, and to support said toner container by pushing back with a resilience force of said arm-like extension member.

8. The image forming apparatus according to claim 7, wherein said free end of said arm-like extension member includes a surface that contacts said first end of said toner container, and wherein said surface has a rounded shape or a semispherical shape.

9. The image forming apparatus according to claim 7, wherein said arm-like extension member is configured to be extended from said top portion downwardly towards said toner container, and said free end of said arm-like extension member includes a supporting surface to contact said first end of said toner container.

10. The image forming apparatus according to claim 7, wherein said toner container has a protective structure protecting movement of said toner container in a direction opposite from a direction in which said toner container is inserted.

11. The image forming apparatus according to claim 7, wherein said base pillar extends in a direction parallel to a direction in which said toner container is inserted and includes an engagement portion, and an edge side of said base plate to which said first supporter is mounted includes a counter engaging portion to which said engagement portion is detachably engaged in the direction in which said toner container is inserted.

12. The image forming apparatus according to claim 1, wherein said toner container holder further includes a rotary supporting mechanism for positioning a rotary center of said toner container and allowing a rotation of said toner container.

13. The image forming apparatus according to claim 1, further comprising a second toner container, wherein said toner container holder is configured to hold said second toner container, and wherein said toner container holder is slantingly arranged such that said first container is provided at a higher elevation that said second toner container.

14. An image developing apparatus, comprising:
a toner container configured to contain toner;
an image development mechanism configured to develop an electrostatic latent image with a developing unit into a toner image using the toner contained in said toner container;
a toner container driving mechanism configured to drive said toner container in rotation; and
a toner container holder configured to rotatably hold said toner container, said toner container holder including a base plate configured to form an upper-open space into which said toner container is inserted from above in a substantially vertical direction.

15. The image developing apparatus according to claim 14, wherein said toner container holder is slantingly arranged.

16. The image developing apparatus according to claim 14, wherein said toner container holder is slantingly arranged such that an end side thereof close to a fixing unit is positioned lower than an opposite end side.

17. The image developing apparatus according to claim 14, wherein said toner container holder is slantingly arranged in a manner substantially parallel to an arrangement of a transfer belt upon which toner image is transferred.

18. The image developing apparatus according to claim 14, wherein said toner container holder is slantingly arranged in a manner substantially parallel to an arrangement of said image development mechanism.

19. The image developing apparatus according to claim 14, wherein said base plate of the toner container is covered by a cover, and wherein said cover includes an upper surface having an ejection tray portion configured to receive sheets ejected from said image forming apparatus.

20. An image forming apparatus, comprising:
a toner container configured to contain toner;
an image development mechanism configured to develop an electrostatic latent image with a developing unit into a toner image using the toner contained in said toner container; and
a toner container holder including:
a base plate;
a first supporter supporting a first end of said toner container and including a base pillar mounted to said base plate; and
a second supporter supporting a second end of said toner container and mounted to said base plate,
wherein said base pillar includes an arm-like extension member configured to support said toner container by pushing against said toner container with a resilience force.
